(19) United States
(12) Patent Application Publication
(10) Pub. No.: US 2025/0277949 A1
(43) Pub. Date: Sep. 4, 2025

(54) OPTICAL BRANCHING CABLE SET

(71) Applicants: SUMITOMO ELECTRIC INDUSTRIES, LTD., Osaka-shi (JP); SUMITOMO ELECTRIC OPTIFRONTIER CO., LTD., Yokohama-shi (JP)

(72) Inventors: Shunichi WATANABE, Osaka-shi (JP); Takayuki SHIMAZU, Osaka-shi (JP); Junji FUKUI, Kanagawa (JP); Masahiro SHIBATA, Kanagawa (JP); Yohei AOSHIMA, Kanagawa (JP)

(73) Assignees: SUMITOMO ELECTRIC INDUSTRIES, LTD., Osaka-shi (JP); SUMITOMO ELECTRIC OPTIFRONTIER CO., LTD., Yokohama-shi (JP)

(21) Appl. No.: 19/069,867

(22) Filed: Mar. 4, 2025

(30) Foreign Application Priority Data
Mar. 4, 2024 (JP) 2024-032396
Mar. 4, 2024 (JP) 2024-032397
May 20, 2024 (JP) 2024-081993

(51) Int. Cl. G02B 6/44

(52) U.S. Cl. CPC G02B 6/444

(57) ABSTRACT

An optical branching cable set includes a plurality of optical branching cables, and a branching cord bag. At least two of the optical branching cables each include a main cable including a plurality of optical cords each including at least one optical fiber, a tensile strength member, and a tape that forms an outermost layer. A branching cord portion including at least one optical fiber that is led out from the optical cords of the main cable to an outside of the outermost layer. The branching cord bag is configured to collectively accommodate a plurality of branching cord portions provided in the plurality of optical branching cables.

### CROSS-REFERENCE TO RELATED APPLICATIONS

This application is based on and claims priority under 35 USC 119 from Japanese Patent Application No. 2024-081993 filed on May 20, 2024, Japanese Patent Application No. 2024-032396 filed on Mar. 4, 2024, and Japanese Patent Application No. 2024-032397 filed on Mar. 4, 2024, the entire content of which is incorporated herein by reference.

### TECHNICAL FIELD

The present disclosure relates to an optical branching cable set.

### BACKGROUND ART

JP2023-083096A discloses an optical branching cable that connects a server rack group including a plurality of server racks and a distribution board. The optical branching cable includes a main cable and branching cords that branch from the main cable and that are connected to the server racks.

The arrangement of the server racks in the server rack group varies depending on the intended use. Therefore, the optical branching cable is manufactured such that the positions of the branching portions, where the main cable and the branching cord portion are branched, correspond to the arrangement of the server racks. The branching cord portion needs to be sufficiently protected at the time of laying, and it is also important that the optical branching cable be easy to manufacture.

### SUMMARY OF INVENTION

Aspect of non-limiting embodiments of the present disclosure relates to provide an optical branching cable set that achieves both protection of a branching cord portion and ease of manufacture.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an optical branching cable set including:
a plurality of optical branching cables; and
a branching cord bag,
in which at least two of the optical branching cables each include:
   a main cable including:
      a plurality of optical cords each including at least one optical fiber;
      a tensile strength member; and
      a tape that forms an outermost layer; and
   a branching cord portion including at least one optical fiber that is led out from the optical cords of the main cable to an outside of the outermost layer, and
the branching cord bag is configured to collectively accommodate a plurality of branching cord portions provided in the plurality of optical branching cables.

### BRIEF DESCRIPTION OF DRAWINGS

Exemplary embodiment(s) of the present invention will be described in detail based on the following figures, wherein:

FIG. 1 shows an optical communication system according to the present embodiment;

FIG. 2 is a schematic view of an optical branching cable;

FIG. 3 is a cross-sectional view of a main cable;

FIG. 4 is a schematic diagram of an optical branching cable set according to a first embodiment;

FIG. 5 shows a curved optical branching cable and a branching cord bag;

FIG. 6 is a cross-sectional view taken along a plane orthogonal to the axis of the main cable of the optical branching cable set;

FIG. 7 shows the branching cord bag in a first stage;

FIG. 8 shows the branching cord bag in a second stage;

FIG. 9 shows the branching cord bag in a third stage;

FIG. 10 is a perspective view of an optical branching cable set according to a third embodiment;

FIG. 11 shows the optical branching cable set and a branching cord bag according to the third embodiment; and

FIG. 12 shows an example of arrangement of branching cord portions of optical branching cables.

### DESCRIPTION OF EMBODIMENTS

### Description of Embodiments of Present Disclosure

First, aspects of the present disclosure will be listed and described. (1) An optical branching cable set according to an aspect of the present disclosure including: a plurality of optical branching cables; and a branching cord bag, in which at least two of the optical branching cables each include a main cable including a plurality of optical cords each including at least one optical fiber, a tensile strength member, and a tape that forms an outermost layer, and a branching cord portion including at least one optical fiber that is led out from the optical cords of the main cable to an outside of the outermost layer, and in which the branching cord bag is configured to collectively accommodate a plurality of branching cord portions provided in the plurality of optical branching cables.

According to the optical branching cable set described above, the branching cord bag can collectively accommodate the branching cord portions of the plurality of optical branching cables. Therefore, the plurality of branching cord portions are protected by the branching cord bags, the number of which is smaller than that of the optical branching cables. Accordingly, since the number of components is reduced, it is possible to provide the optical branching cable set that achieves both protection of the branching cord portion and ease of manufacture.

(2) In the optical branching cable set according to (1) described above, the branching cord bag may be made of a material having a cushioning property.

According to the optical branching cable set described above, since the branching cord bag is made of a material having the cushioning property, the branching cord portion is more effectively protected.

(3) In the optical branching cable set according to (1) or (2) described above, the branching cord bag may be fixed to the plurality of optical branching cables at two different locations along the main cable.

According to the optical branching cable set described above, the branching cord bag is fixed to the plurality of optical branching cables at two different locations along the main cable. Therefore, the optical branching cable set can be manufactured easily, and the branching cord bag can be firmly fixed to the optical branching cable.

(4) In the optical branching cable set according to any one of (1) to (3) described above, the branching cord bag may include a base portion that is sandwiched between the main cable and the branching cord portion in a state where the branching cord portion is accommodated in the branching cord bag, and a top surface portion that is located so as to cover an upper portion of the branching cord portion in a state where the branching cord portion is accommodated in the branching cord bag, the base portion may not cover a branching portion to which the branching cord portion is led out from the main cable, and the top surface portion may have a larger dimension along an axis of the main cable than the base portion so as to cover the branching portion.

According to the optical branching cable set described above, the base portion does not cover the branching portion. Therefore, it is easy to perform the operation of accommodating the branching cord portion led out from the branching portion. The top surface portion is formed larger than the base portion so as to cover the branching portion. Therefore, the branching cord portion including the branching portion can be protected.

(5) In the optical branching cable set according to any one of (1) to (4) described above, the branching cord bag may include an inner bag configured to be accommodated inside the branching cord bag, and the inner bag may accommodate at least a part of the branching cord portions of the optical branching cables.

According to the optical branching cable set described above, since the inner bag can be accommodated in the branching cord bag and the branching cord portion can be accommodated, the branching cord portion is more effectively protected.

(6) In the optical branching cable set according to any one of (1) to (5) described above, an outer surface of the branching cord bag may be formed with an extra length that extends according to a curvature of the optical branching cable.

The optical branching cable may be curved during manufacturing when, for example, the optical branching cable is wrapped around a drum. According to the optical branching cable set described above, the extra length that extends along the curvature of the optical branching cable is formed. Therefore, by providing the sufficient extra length, the branching cord bag is less likely to fall off the optical branching cable.

### Details of Embodiments of Present Disclosure

Specific examples of an optical branching cable and an optical branching cable set according to an embodiment of the present disclosure will be described below with reference to the drawings. The present disclosure is not limited to these exemplifications, but is indicated by the scope of claims, and is intended to include all changes within a scope and meaning equivalent to the scope of claims.

In the drawings, an arrow F indicates the forward direction of the illustrated structure. An arrow B indicates the rearward direction of the illustrated structure. An arrow U indicates the upward direction of the illustrated structure. An arrow D indicates the downward direction of the illustrated structure. An arrow R indicates the rightward direction of the illustrated structure. An arrow L indicates the leftward direction of the illustrated structure. These expressions related to the directions are used for convenience of description, and are not intended to limit the posture and direction of the illustrated structure in the actual use state.

### Optical Branching Cable

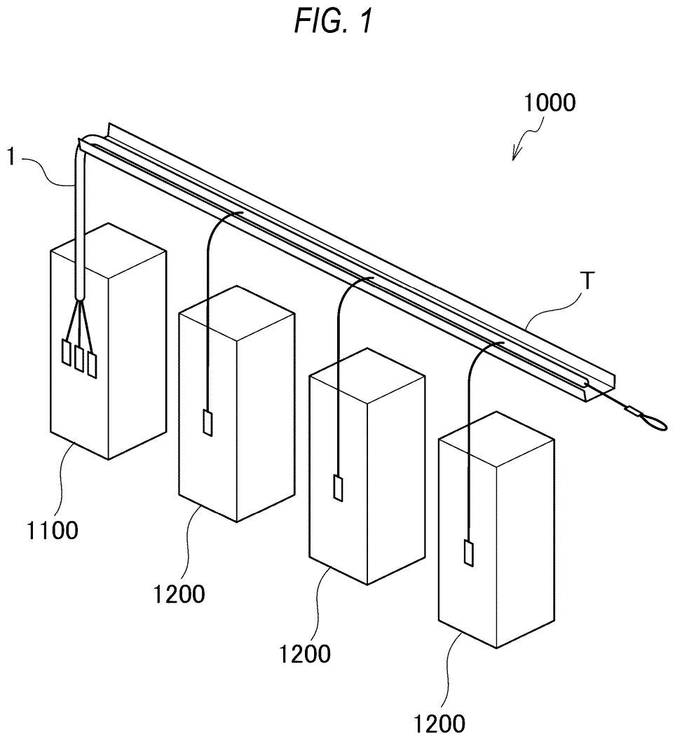

FIG. 1 shows an optical communication system 1000 according to the present embodiment. As shown in FIG. 1, the optical communication system 1000 includes a distribution board 1100 and a plurality of server racks 1200. Optical branching cables 1 used in the optical communication system 1000 are collected and connected to the distribution board 1100. The optical branching cable 1 is an example of an optical cable. The server rack 1200 accommodates a physical server therein. An optical fiber that is branched from the optical branching cable 1 is connected to each of the server racks 1200. The optical branching cable 1 is laid on a cable laying tray T, and is wired to the distribution board 1100 and the server rack 1200. The cable laying tray T is an example of a traction path.

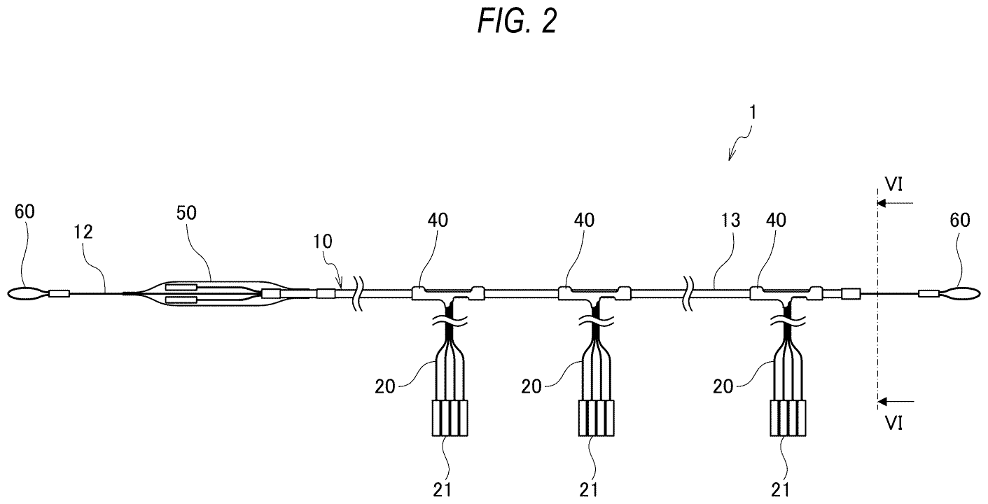

FIG. 2 is a schematic view of the optical branching cable 1. As shown in FIG. 2, the optical branching cable 1 includes a main cable 10, a branching cord portion 20, a bend restricting component 40, a distal end bag 50, and a connection loop 60.

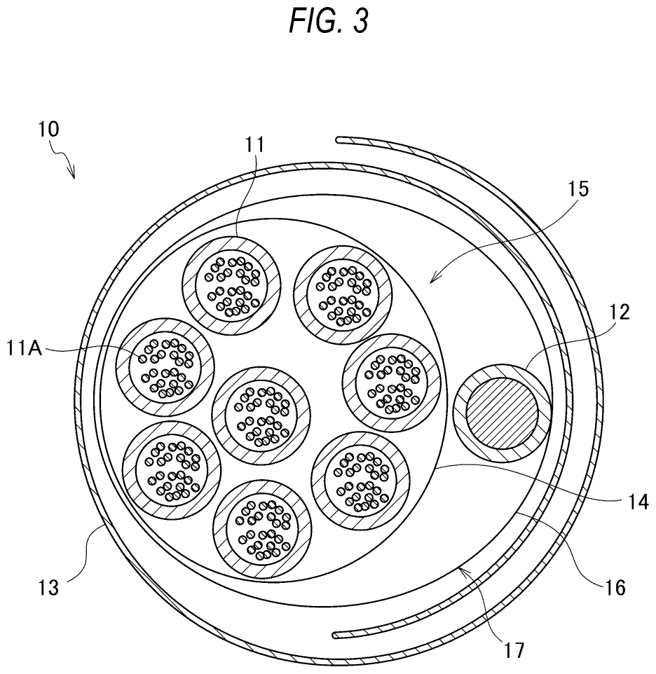

FIG. 3 is a cross-sectional view of the main cable 10. The main cable 10 includes a plurality of optical cords 11, a tensile strength member 12, and a tape 13. The optical cord 11, the tensile strength member 12, and the tape 13 are provided along the longitudinal direction of the main cable 10. The main cable 10 is also an example of an optical cable.

Each of the optical cords 11 includes at least one optical fiber 11A therein. In the present embodiment, the optical cord 11 includes 24 optical fibers 11A therein. The plurality of optical cords 11 are bundled together in a first bundle 14 to form an optical cord group 15.

The tensile strength member 12 is made of fiber reinforced plastic (FRP) such as aramid FRP, glass FRP, or carbon FRP. The tensile strength member 12 is configured to share the tension when the optical branching cable 1 is pulled, so that excessive tension is not applied to the optical fiber 11A. The optical cord group 15 and the tensile strength member 12 are bundled together in a second bundle 16 to form a core portion 17.

The tape 13 forms the outermost layer of the main cable 10. The tape 13 is longitudinally folded around the core portion 17 so as to maintain a shape that covers the core portion 17. The tape 13 is a sheet-shaped insulating resin, and may be made of, for example, polyester.

The tape 13 is longitudinally folded such that a gap is formed between the tape 13 and the core portion 17. Therefore, the outer diameter of the main cable 10 is configured to be contracted by an external force.

Returning to FIG. 2, the branching cord portion 20 is a cord in which at least one optical fiber 11A is led out from the optical cord 11 of the main cable 10 to the outside of the tape 13 which is the outermost layer. An optical connector 21 is provided at the distal end of the branching cord portion 20. The branching cord portion 20 may be a portion in which the optical fiber 11A in the optical cord 11 is led outward from the outermost layer of the main cable 10, or the optical cord 11 itself may be led outward from the outermost layer of the main cable 10.

The bend restricting component 40 is mounted at a position corresponding to a branching portion BR of the optical branching cable 1. The bend restricting component 40 is provided at the branching portion BR such that bending with a radius of curvature smaller than a predetermined radius of curvature is less likely to occur in the branching cord portion 20 led out from the main cable 10.

The distal end bag 50 protects the end portion of the optical cord 11 that is exposed at the distal end of the main cable 10, and the end portion optical connector that is provided at the end portion of the optical cord 11.

The connection loop 60 is connected to the tensile strength member 12 that is exposed at the distal end of the optical branching cable 1. The connection loop 60 is a portion that is connected to a traction device such as a winch. The connection loop 60 is formed in a ring shape, and when the connection loop 60 is pulled, a tension is applied to the tensile strength member 12, and the optical branching cable 1 can be displaced.

### First Embodiment

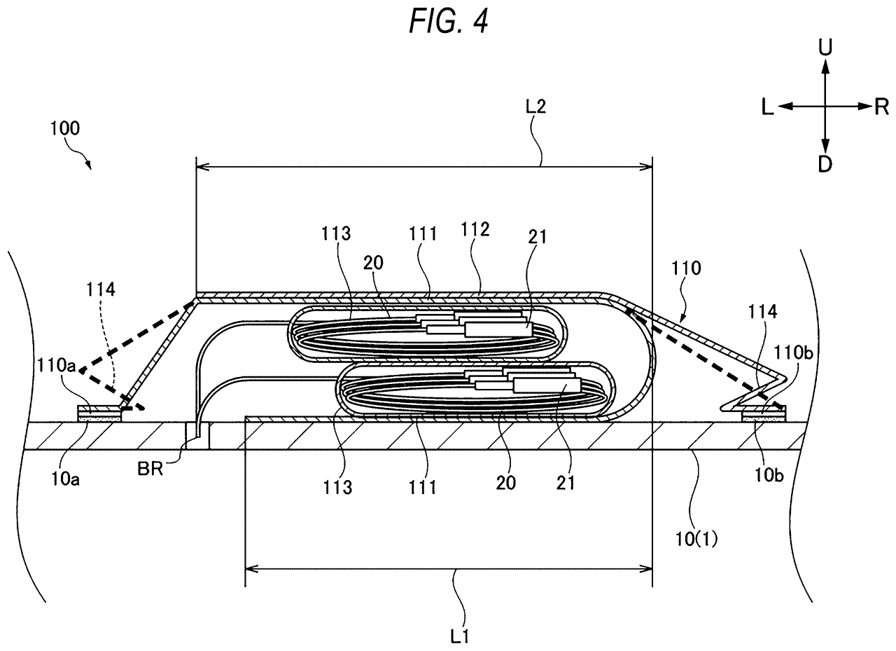

Next, an optical branching cable set 100 according to the first embodiment will be described. FIG. 4 is a schematic diagram of the optical branching cable set 100 according to the first embodiment. As shown in FIG. 4, the optical branching cable set 100 includes a plurality of optical branching cables 1 and a branching cord bag 110. The plurality of optical branching cables 1 are arranged side by side in the depth direction of the paper in FIG. 4.

The branching cord bag 110 is configured to collectively accommodate a plurality of branching cord portions 20 provided in the plurality of optical branching cables 1. In the present embodiment, the branching cord portion 20 that is led out from the branching portion BR is wrapped in a coil shape and accommodated in the branching cord bag 110 together with the optical connector 21.

The branching cord bag 110 may be made of a material having the cushioning property. The material having the cushioning property is, for example, a void cushioning material, a cloth material, or a resin material whose surface can be temporarily recessed.

The branching cord bag 110 may be fixed to the optical branching cable 1 at two different locations along the main cable 10. In the present embodiment, the branching cord bag 110 is fixed to the main cable 10 by a hook-and-loop fastener. The branching cord bag 110 is provided with a first hook-and-loop fastener 110a and a second hook-and-loop fastener 110b. The first hook-and-loop fastener 110a and the second hook-and-loop fastener 110b form the hook surface of the hook-and-loop fastener. The first hook-and-loop fastener 110a is located in the leftward direction with respect to the second hook-and-loop fastener 110b.

The main cable 10 is provided with a third hook-and-loop fastener 10a and a fourth hook-and-loop fastener 10b. The third hook-and-loop fastener 10a and the fourth hook-and-loop fastener 10b form the loop surface of the hook-and-loop fastener. The third hook-and-loop fastener 10a is located in the leftward direction with respect to the fourth hook-and-loop fastener 10b. The third hook-and-loop fastener 10a and the fourth hook-and-loop fastener 10b may be formed on the main cable 10 of the plurality of optical branching cables 1 arranged in parallel.

The first hook-and-loop fastener 110a is configured to adhere to the third hook-and-loop fastener 10a. The second hook-and-loop fastener 110b is configured to adhere to the fourth hook-and-loop fastener 10b. The first hook-and-loop fastener 110a and the second hook-and-loop fastener 110b adhere to the third hook-and-loop fastener 10a and the fourth hook-and-loop fastener 10b, respectively, so that the branching cord bag 110 is fixed to the optical branching cable 1 at two different locations along the main cable 10.

The branching cord bag 110 includes a base portion 111 and a top surface portion 112. The base portion 111 is sandwiched between the main cable 10 and the branching cord portion 20 in a state where the branching cord portion 20 is accommodated in the branching cord bag 110. The top surface portion 112 is located so as to cover the upper portion of the branching cord portion 20 in a state where the branching cord portion 20 is accommodated in the branching cord bag 110.

The base portion 111 does not cover the branching portion BR to which the branching cord portion 20 is led out from the main cable 10. On the other hand, the top surface portion 112 can cover the branching portion BR. When the dimension of the base portion 111 along the main cable 10 is L1 and the dimension of the top surface portion 112 along the main cable 10 is L2, the base portion 111 and the top surface portion 112 are formed so as to satisfy L1<L2. That is, the top surface portion 112 has a larger dimension along the axis of the main cable 10 than the base portion 111.

The branching cord bag 110 includes an inner bag 113 configured to be accommodated inside the branching cord bag 110. In the present embodiment, the branching cord bag 110 includes two inner bags 113.

The inner bag 113 is configured to accommodate at least a part of the branching cord portion 20 of the optical branching cable 1. In the present embodiment, all the branching cord portions 20 that are accommodated in the branching cord bag 110 are accommodated separately in the two inner bags 113.

The inner bag 113 may be made of a material that is slippery relative to the inner surface of the branching cord bag 110. For example, the inner bag 113 may be made of plastic. Accordingly, it is easy to perform the operation of storing and removing the inner bag 113 from the branching cord bag 110.

The outer surface of the branching cord bag 110 may be formed with an extra length 114 that extends according to the curvature of the optical branching cable 1. In the present embodiment, the extra length 114 is formed in a folded manner on the outer surface of the right side of the branching cord bag 110. Alternatively, the extra length 114 may be formed on the outer surface of the left side of the branching cord bag 110, as shown by the dashed line. The extra length 114 may be formed on both the outer surfaces of the left and right sides of the branching cord bag 110.

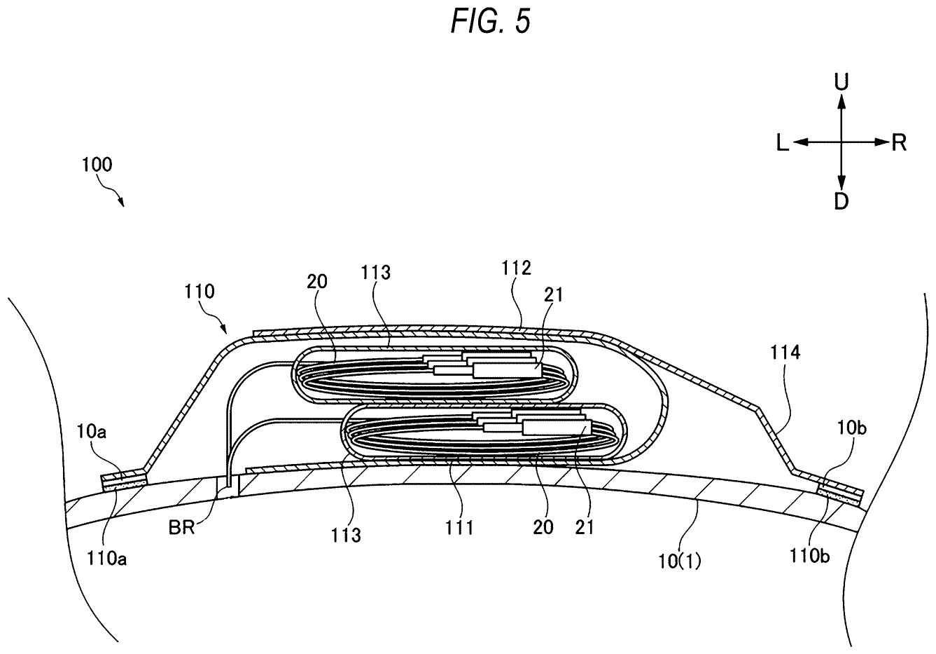

FIG. 5 shows the curved optical branching cable 1 and the branching cord bag 110. As shown in FIG. 5, the optical branching cable 1 may be curved in the process of the operations such as manufacturing, transportation, and laying. For example, the optical branching cable 1 may be wrapped around a drum during manufacturing, and in this case, the optical branching cable set 100 is curved so as to be convex in the upward direction, which is the side on which the branching cord bag 110 is provided.

As the optical branching cable 1 is curved, the stress is applied to the branching cord bag 110 such that the branching cord bag 110 is stretched in the leftward direction and the rightward direction. In this case, the folded extra length 114 unfolds and extends along the curvature of the optical branching cable 1, so that the branching cord bag 110 is less likely to be forcibly deformed, and the branching cord bag 110 is less likely to fall off the optical branching cable 1.

According to the optical branching cable set 100 in the present embodiment, the branching cord bag 110 is configured to collectively accommodate the branching cord portions 20 of the plurality of optical branching cables 1. Therefore, the plurality of branching cord portions 20 are protected by the branching cord bags 110, the number of which is smaller than that of the optical branching cables 1. Accordingly, since the number of components is reduced, it is possible to provide the optical branching cable set 100 that achieves both protection of the branching cord portion 20 and ease of manufacture.

Since the optical branching cable set 100 according to the present embodiment is made of a material having the cushioning property, the branching cord portion 20 is more effectively protected.

According to the optical branching cable set 100 in the present embodiment, the branching cord bag 110 is fixed to the plurality of optical branching cables 1 at two different locations along the main cable 10. Therefore, the optical branching cable set 100 can be manufactured easily, and the branching cord bag 110 can be firmly fixed to the optical branching cable 1.

According to the optical branching cable set 100 in the present embodiment, the base portion 111 does not cover the branching portion BR. Therefore, it is easy to perform the operation of accommodating the branching cord portion 20 led out from the branching portion BR. The top surface portion 112 is formed larger than the base portion 111 so as to cover the branching portion BR. Therefore, the branching cord portion 20 including the branching portion BR can be protected.

According to the optical branching cable set 100 in the present embodiment, since the inner bag 113 can be accommodated in the branching cord bag 110 and the branching cord portion 20 can be accommodated, the branching cord portion 20 is more effectively protected.

In the present embodiment, all the branching cord portions 20 that are accommodated in the branching cord bag 110 are accommodated separately in the two inner bags 113. Accordingly, the branching cord portions 20 can be accommodated in a divided state in the branching cord bag 110 according to the connection place of the branching cord portion 20 and the necessary work. In particular, the work of connecting the plurality of branching cord portions 20 to the server rack 1200 is likely to be complicated since a large number of branching cord portions 20 are to be connected. Since the branching cord portions 20 are divided by the inner bag 113, the laying work can be performed more efficiently.

According to the optical branching cable set 100 in the present embodiment, the extra length 114 that extends along the curvature of the optical branching cable 1 is formed in the branching cord bag 110. Therefore, by providing the sufficient extra length 114, the branching cord bag 110 is less likely to fall off the optical branching cable 1.

### Second Embodiment

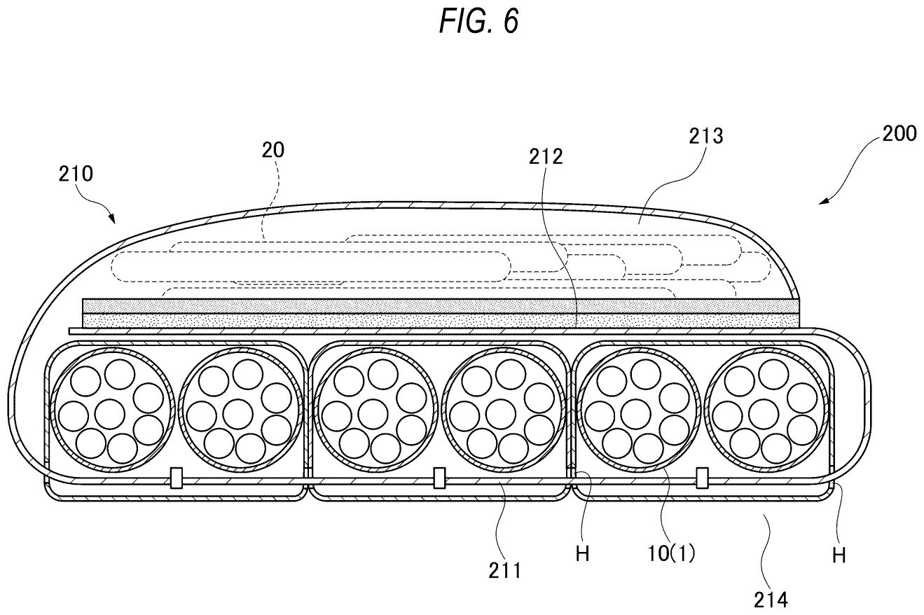

Next, an optical branching cable set 200 according to a second embodiment will be described. FIG. 6 is a cross-sectional view taken along a plane orthogonal to the axis of the main cable 10 of the optical branching cable set 200. Similarly to the optical branching cable set 100 according to the first embodiment, the optical branching cable set 200 includes the plurality of optical branching cables 1 and a branching cord bag 210. The branching cord bag 210 is configured to collectively accommodate the plurality of branching cord portions 20 provided in the plurality of optical branching cables 1.

The branching cord bag 210 is mounted so as to be wrapped around the main cable 10 and the branching cord portion 20. The branching cord bag 210 includes a first portion 211, a second portion 212, and a third portion 213. The first portion 211 is located below the main cable 10. The first portion 211 has a plurality of through holes H formed therein. The second portion 212 is sandwiched between the main cable 10 and the branching cord portion 20. The third portion 213 covers the upper portion of the branching cord portion 20.

The main cable 10 is fixed to the branching cord bag 210 by a bundling member 214. The bundling member 214 is wrapped around the first portion 211 and the two main cables 10 through the through hole H. Accordingly, the main cable 10 is restricted from moving upward, forward, and rearward relative to the first portion 211.

The second portion 212 and the third portion 213 adhere to each other by a hook-and-loop fastener. Accordingly, the space between the second portion 212 and the third portion 213 is closed, and the branching cord portion 20 is less likely to come out of the branching cord bag 210.

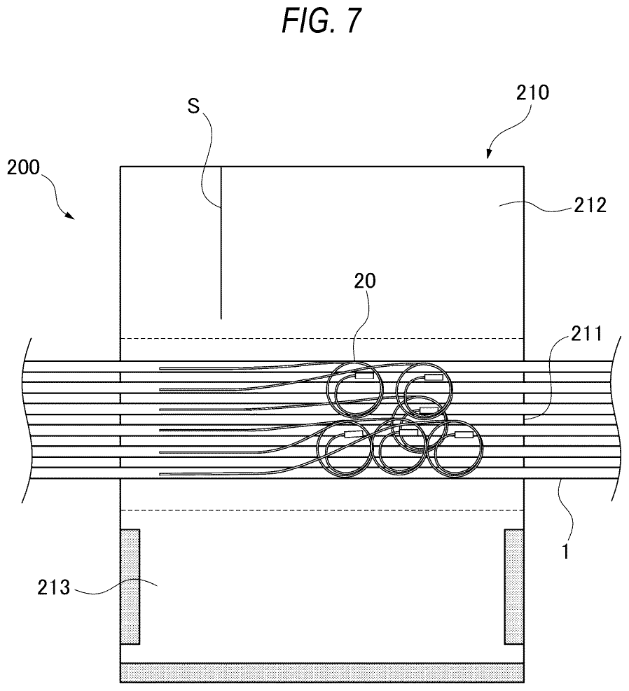

Next, the assembly of the branching cord bag 210 will be described. The branching cord bag 210 is assembled through a first stage, a second stage, and a third stage. FIG. 7 shows the branching cord bag 210 in the first stage. The dashed line indicates the boundary between the first portion 211, the second portion 212, and the third portion 213. The branching cord bag 210 in the first stage is not assembled with the first portion 211, the second portion 212, and the third portion 213. The optical branching cable 1 is placed on the first portion 211.

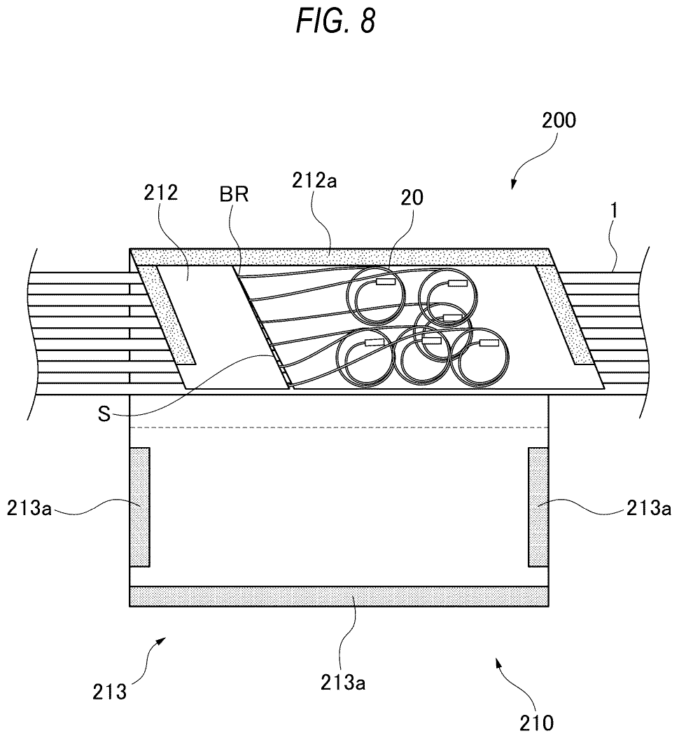

FIG. 8 shows the branching cord bag 210 in the second stage. As shown in FIG. 8, in the second stage, the second portion 212 is folded onto the main cable 10. Further, the branching cord portion 20 is provided on the second portion 212. The second portion 212 has a slit S formed therein (see also FIG. 7). The branching cord portion 20 that is led out from the main cable 10 in the branching portion BR is provided on the second portion 212 through the slit S.

The second portion 212 is provided with a fifth hook-and-loop fastener 212a. The fifth hook-and-loop fastener 212a faces upward when the second portion 212 is folded onto the main cable 10. The fifth hook-and-loop fastener 212a forms the hook surface of the hook-and-loop fastener.

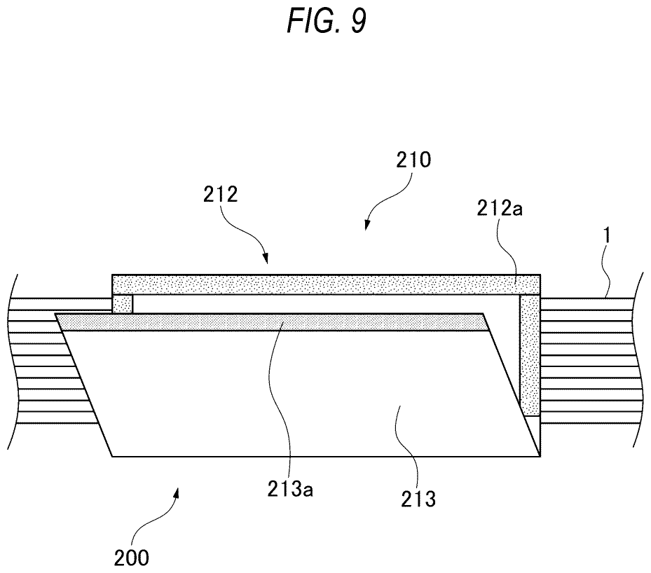

FIG. 9 shows the branching cord bag 210 in the third stage. As shown in FIG. 9, in the third stage, the third portion 213 is folded over onto the branching cord portion 20. Accordingly, the branching cord portion 20 is accommodated between the second portion 212 and the third portion 213.

The third portion is provided with a sixth hook-and-loop fastener 213a (see also FIG. 8). When the third portion 213 is folded onto the branching cord portion 20, at least a part of the sixth hook-and-loop fastener 213a faces downward. The sixth hook-and-loop fastener 213a forms the loop surface of the hook-and-loop fastener.

In the third stage, the fifth hook-and-loop fastener 212a and the sixth hook-and-loop fastener 213a is configured to adhere to each other. The fifth hook-and-loop fastener 212a and the sixth hook-and-loop fastener 213a adhere to each other, so that the assembly of the branching cord bag 210 is completed.

According to the optical branching cable set 200 in the second embodiment, the branching cord bag 210 is configured to collectively accommodate the branching cord portions 20 of the plurality of optical branching cables 1. Therefore, the plurality of branching cord portions 20 are protected by the branching cord bags 210, the number of which is smaller than that of the optical branching cables 1. Accordingly, since the number of components is reduced, it is possible to provide the optical branching cable set 200 that achieves both protection of the branching cord portion 20 and ease of manufacture.

### Third Embodiment

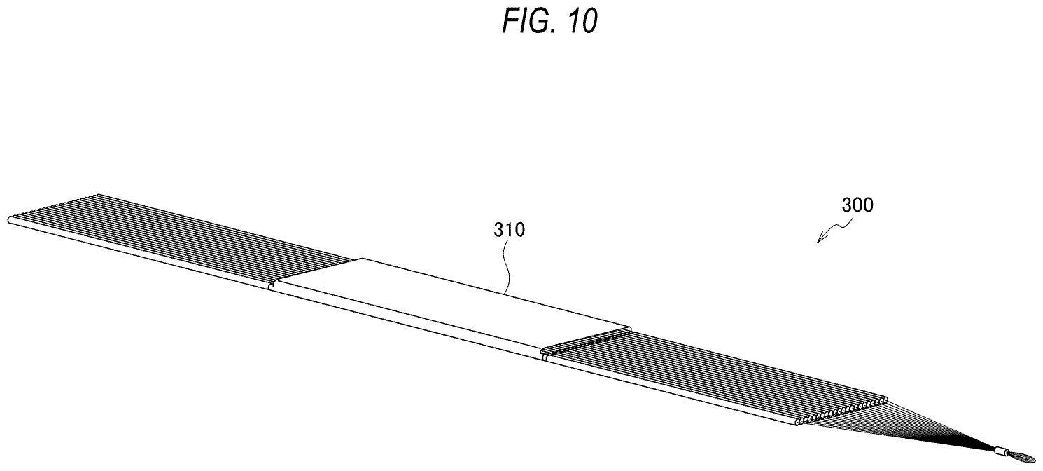

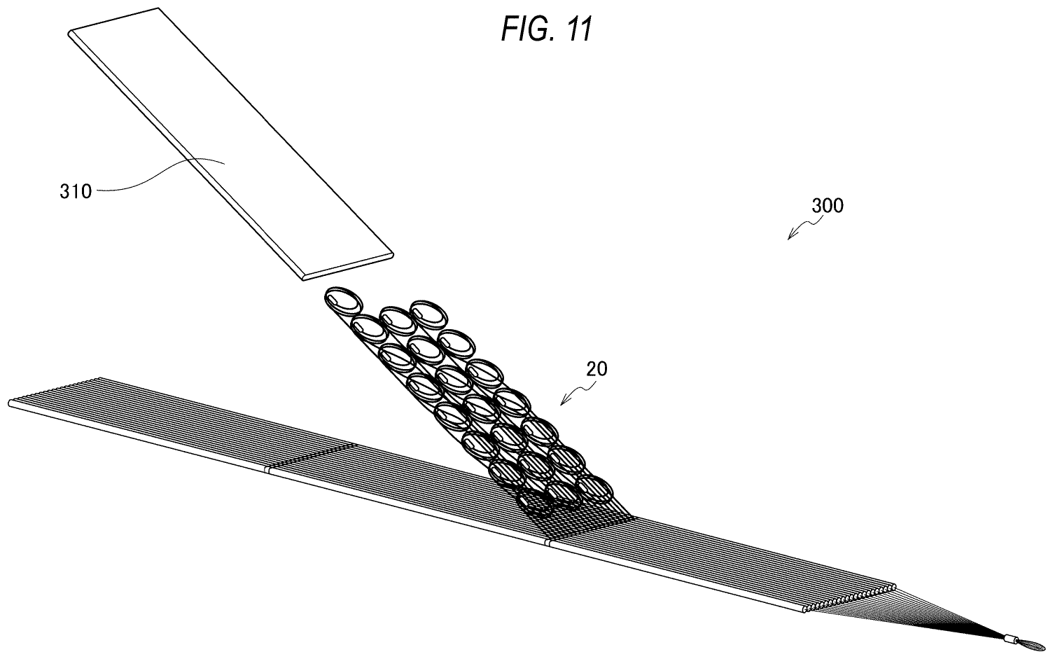

Next, an optical branching cable set 300 according to a third embodiment will be described. FIG. 10 is a perspective view of the optical branching cable set 300 according to the third embodiment. FIG. 11 shows the optical branching cable set 300 and a branching cord bag 310 according to the third embodiment.

The optical branching cable set 300 according to the third embodiment includes 22 optical branching cables 1. One branching cord bag 310 accommodates 22 branching cord portions 20.

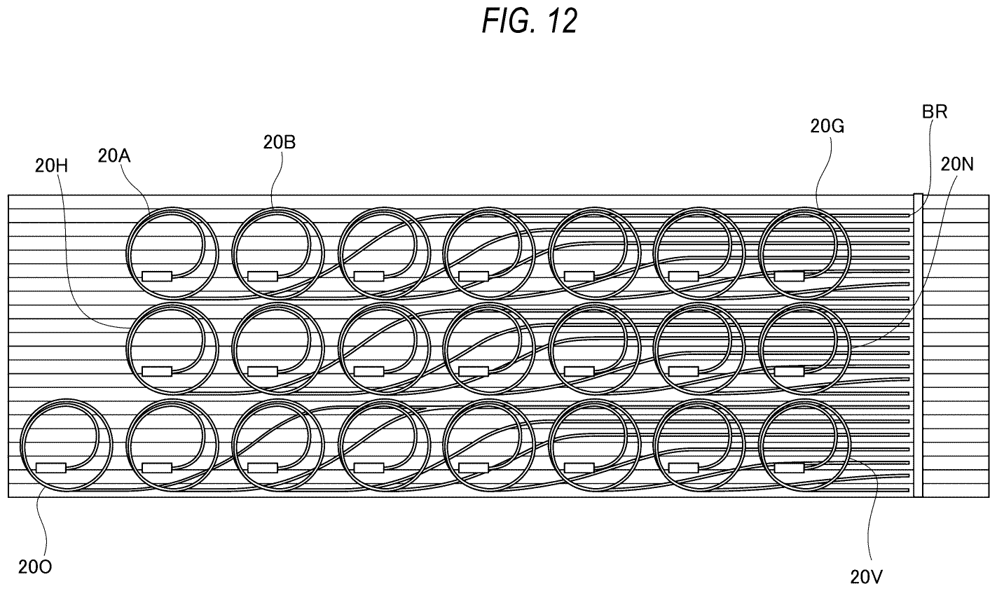

FIG. 12 shows an example of arrangement of branching cord portions 20 of the optical branching cables 1. For the sake of description, the optical branching cables 1 will be referred to as a first optical branching cable, a second optical branching cable, . . . , and a twenty-second optical branching cable, in the order in which the optical branching cables are arranged from the top to the bottom on the paper surface of FIG. 12. Similarly, the branching cord portions 20 provided in the first optical branching cable, the second optical branching cable, . . . , and the twenty-second optical branching cable will be referred to as a first branching cord portion 20A, a second branching cord portion 20B, . . . , and a twenty-second branching cord portion 20V.

As shown in FIG. 12, the branching cord portion 20 is divided into three rows in the longitudinal direction of the optical branching cable 1. The branching cord portions 20 from the first branching cord portion 20A to the seventh branching cord portion 20G are provided in the upper row. The branching cord portions 20 from the eighth branching cord portion 20H to the fourteenth branching cord portion 20N are provided in the central row. The branching cord portions 20 from the fifteenth branching cord portion 200 to the twenty-second branching cord portion 20V are provided in the lower row. Each branching cord portion 20 is wrapped clockwise in a coil shape in the plan view.

The branching cord portion 20 may be provided such that the bending radius is as large as possible. For example, in the upper row, the first branching cord portion 20A is provided at a position farthest from the branching portion BR. The first branching cord portion 20A to the seventh branching cord portion 20G are arranged in this order at positions farther away from the branching portion BR. In other words, the seventh branching cord portion 20G is provided at a position closest to the branching portion BR.

Similarly, in the central row, the eighth branching cord portion 20H is provided at a position farthest from the branching portion BR. The eighth branching cord portion 20H to the fourteenth branching cord portion 20N are arranged in this order at positions farther away from the branching portion BR. In other words, the fourth branching cord portion 20N is provided at a position closest to the branching portion BR. In the lower row, the fifteenth branching cord portion 20O is provided at a position farthest from the branching portion BR. The fifteenth branching cord portion 20O and the twenty-second branching cord portion 20V are arranged in this order at positions farther away from the branching portion BR. In other words, the twenty-second branching cord portion 20V is provided at a position closest to the branching portion BR.

By arranging the branching cord portions 20 in this manner, the branching cord portion 20 provided closest to the branching portion BR is the branching cord portion 20 of the rightmost optical branching cable 1 in each row. At this time, when the branching cord portion 20 is wrapped clockwise into a coil shape, the branching cord portion 20 provided closest to the branching portion BR is less likely to be bent with a bending radius smaller than a predetermined bending radius.

Since the branching cord portions 20 are also arranged in order when the branching cord portions 20 are removed, it is difficult to mix up the branching cord portions 20 when connecting the branching cord portions 20 to the server rack 1200 or the like, and the connection work of the branching cord portions 20 is easy.

According to the optical branching cable set 300 in the third embodiment, the branching cord bag 310 can collectively accommodate the branching cord portions 20 of the plurality of optical branching cables 1. Therefore, the plurality of branching cord portions 20 are protected by the branching cord bags 310, the number of which is smaller than that of the optical branching cables 1. Accordingly, since the number of components is reduced, it is possible to provide the optical branching cable set 300 that achieves both protection of the branching cord portion 20 and ease of manufacture.

Although the present disclosure has been described in detail with reference to the specific embodiments, it is apparent to those skilled in the art that various changes and modifications can be made without departing from the spirit and scope of the present disclosure. In addition, the number, positions, shapes, and the like of the constituent members described above are not limited to those in the above embodiments, and can be changed to the numbers, positions, shapes, and the like suitable for carrying out the present disclosure.

The number of inner bags 113 provided in the branching cord bag 110 may be larger or smaller than two.

What is claimed is:

1. An optical branching cable set comprising:
a plurality of optical branching cables; and
a branching cord bag,
wherein at least two of the optical branching cables each include:
a main cable including:
a plurality of optical cords each including at least one optical fiber;
a tensile strength member; and
a tape that forms an outermost layer; and
a branching cord portion including at least one optical fiber that is led out from the optical cords of the main cable to an outside of the outermost layer, and
wherein the branching cord bag is configured to collectively accommodate a plurality of branching cord portions provided in the plurality of optical branching cables.

2. The optical branching cable set according to claim 1,
wherein the branching cord bag is made of a material having a cushioning property.

3. The optical branching cable set according to claim 1,
wherein the branching cord bag is fixed to the plurality of optical branching cables at two different locations along the main cable.

4. The optical branching cable set according to claim 1,
wherein the branching cord bag includes:
a base portion that is sandwiched between the main cable and the branching cord portion in a state where the branching cord portion is accommodated in the branching cord bag; and
a top surface portion that is located so as to cover an upper portion of the branching cord portion in a state where the branching cord portion is accommodated in the branching cord bag,
wherein the base portion does not cover a branching portion to which the branching cord portion is led out from the main cable, and
wherein the top surface portion has a larger dimension along an axis of the main cable than the base portion so as to cover the branching portion.

5. The optical branching cable set according to claim 1,
wherein the branching cord bag includes an inner bag configured to be accommodated inside the branching cord bag, and
wherein the inner bag is configured to accommodate at least a part of the branching cord portions of the optical branching cables.

6. The optical branching cable set according to claim 1,
wherein an outer surface of the branching cord bag is formed with an extra length that extends according to a curvature of the optical branching cable.
